(19) United States
(12) Patent Application Publication
(10) Pub. No.: US 2010/0242286 A1
(43) Pub. Date: Sep. 30, 2010

(54) Hair Cutting Device

(75) Inventors: Norman Yerke, Elm Grove, WI (US); Christopher J. Koenig, West Bend, WI (US)

Correspondence Address: GODFREY & KAHN S.C., 780 NORTH WATER STREET, MILWAUKEE, WI, 53202, US

(73) Assignee: New Life Ventures, LLC, a Wisconsin limited liability company

(21) Appl. No.: 12/731,652

(22) Filed: Mar. 25, 2010

Related U.S. Application Data
(60) Provisional application No. 61/178,577, filed on May 15, 2009.
(60) Provisional application No. 61/163,645, filed on Mar. 26, 2009.

(51) Int. Cl. B26B 19/44

(52) U.S. Cl. 30/133

(57) ABSTRACT

A hair cutting device has a motorized suction assembly and a motorized clipper assembly, with a hair-receiving chamber for containing hair clippings and a filter positioned between the motorized suction assembly and the motorized clipper assembly. Spacers of varying lengths to control the length and style of hair cut may also be provided.

### PRIORITY CLAIM/CROSS-REFERENCE TO RELATED APPLICATIONS

This application claims priority from U.S. Provisional Patent Application Nos. 61/178,577, filed on May 15, 2009, and 61/163,645 filed on Mar. 26, 2009, which are incorporated herein by reference for all purposes.

### FIELD OF THE INVENTION

The present invention relates generally to the field of motorized hair cutting devices.

### BACKGROUND OF THE INVENTION

Various devices in the general field of the invention have been proposed in the past. Examples include U.S. Pat. No. 6,665,938 to McCambridge et al. and U.S. Pat. No. 4,972,584 to Baumann. These devices both have an onboard clipping and suction configuration using a single motor to perform both operations, however, these devices do not perform very well in practice. The McCambridge et al. device is configured to have a small storage area for clipped hair but requires the user to empty it several times during a typical haircut. Further, this device is limited to cutting hair to shorter lengths, i.e., a “buzz cut.” Other hair cutting devices currently on the market, such as the hair clipper sold under the trademark FLOWBEE®, make use of a conventional vacuum cleaner to provide the suction and hair removal. This can be cumbersome and awkward to use because the user needs to hook a long hose attachment to the product and turn on both the vacuum clearer and the clipping product and have to deal with the attached dangling hose. Patents issued to the inventor of the FLOWBEE® hair clipper include U.S. Pat. Nos. 5,231,762; 5,142,786; 4,970,788; 4,679,322; and D311,616.

As such, there is a need for a hair cutting device that is lightweight and compact that houses both a clipping and suction device and temporarily stores hair clippings for later disposal and also that does not require an external source of suction such as a vacuum cleaner.

### SUMMARY OF THE INVENTION

The hair cutting device of the present invention has a motorized suction assembly and a motorized clipper assembly, both at least partially within an enclosure, which are powered by two separate motors. The hair cutting device also has a hair-receiving chamber which is positioned within the enclosure such that pieces of hair cut by the motorized clipper assembly are deposited into the hair-receiving chamber. The motorized suction assembly draws hair into the motorized cutting assembly and deposits the hair clippings into the hair-receiving chamber. A filter is positioned between the motorized suction assembly and the motorized clipper assembly such that pieces of hair cut by the motorized clipper assembly are prevented from being drawn into the motorized suction assembly. The hair cutting device further has the capability of being used with spacers of varying lengths to control the length and style of hair cut. These and other features and advantages of one exemplary embodiment of a hair cutting device in accordance with this invention are described in, or are apparent from, the following description and accompanying Figures.

### BRIEF DESCRIPTION OF THE DRAWINGS

FIG. 1 is an isometric view of one embodiment of a hair cutting device in accordance with the present invention.

FIG. 2 is an exploded isometric view of the device shown in FIG. 1.

FIG. 3 is a side elevation view of the device shown in FIG. 1, with the left enclosure piece removed.

FIG. 4 is an isometric view of the motorized clipper assembly of the device shown in FIG. 1.

FIG. 5 is an isometric exploded view of the motorized clipper assembly of the device shown in FIG. 1.

FIG. 6 is a front elevation view of the motorized clipper assembly showing portions of the cutting plates of the device shown in FIG. 1.

FIG. 7 is an isometric exploded view of the motorized suction assembly of the device shown in FIG. 1.

FIG. 8 is a cross-sectional view of the motorized suction assembly showing the impeller and drive mechanism of the device shown in FIG. 1.

FIG. 9 is an isometric view of a plurality of spacers.

### DETAILED DESCRIPTION OF THE PREFERRED EMBODIMENTS

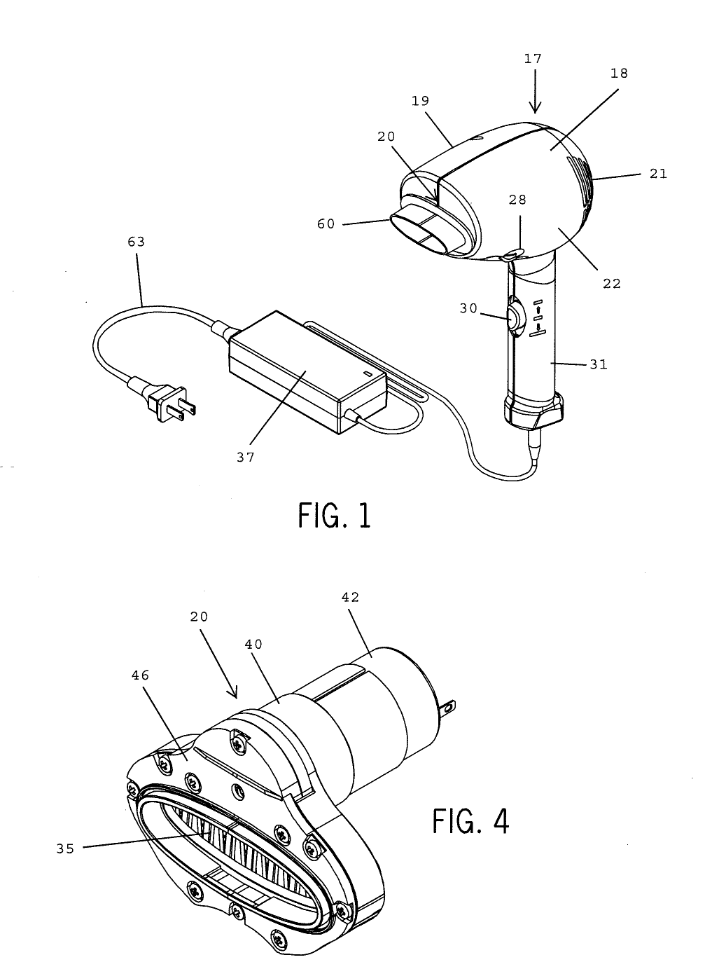

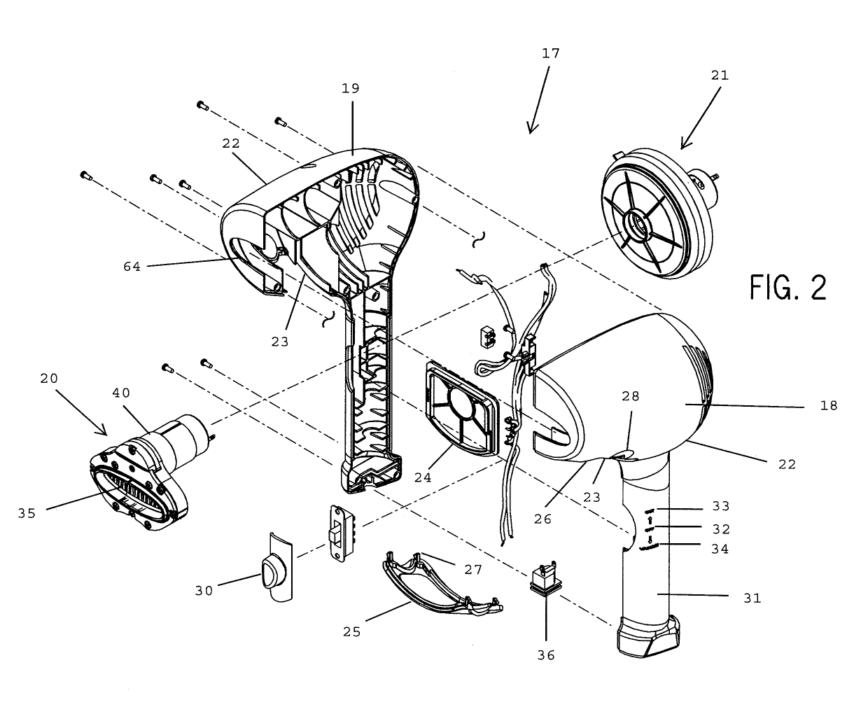

Referring to the figures, as shown in FIGS. 1 and 2, the present invention is a hair cutting device 17 comprising a motorized clipper assembly 20 and a motorized suction assembly 21 both housed in an enclosure 22. The enclosure may be constructed in a variety of different ways. The enclosure 22 shown in FIGS. 1, 2, and 3, is two separate pieces, namely a left enclosure piece 18 and right enclosure piece 19. The enclosure may be any number of connectable pieces, or may be a single body.

The motorized clipper assembly 20 and the motorized suction assembly 22 are powered by two separate motors. The enclosure 22 also houses a hair-receiving chamber 23 for collecting trimmed hair clippings. The hair-receiving chamber 23 is in communication with the motorized suction assembly 21 and the motorized clipper assembly 20. Suction or vacuum produced by the motorized suction assembly 21 draws hair into the motorized clipper assembly 20 and causes hair clippings to be deposited into the hair-receiving chamber 23. A filter 24 is located between the motorized clipper assembly 20 and the motorized suction assembly 21 and is designed to maintain maximum air flow while deflecting and collecting trimmed hair clippings thereby preventing hair or foreign particles from entering the motorized suction assembly 21. The hair-receiving chamber 23 has a movable cover 25 that is used to open and close an aperture 26 in the hair-receiving chamber. When in a closed position, the movable cover is contiguous with the enclosure. In the preferred embodiment, the filter 24 is designed to be removable for replacement and or cleaning and is accessed by opening or removing the movable cover 25.

The movable cover can be attached to the enclosure 22 by a number of different means. For example, the movable cover may be attached by snapping means, sliding means, fasteners, or other attachment methods. The movable cover may be entirely removable, or it may be openable, for example hinged. In the embodiment shown in FIGS. 1, 2, and 3, the movable cover 25 is a cap designed to snap into place via four protruding fingers 27. These fingers have a sharp taper which guide them into the mating rectangular holes in one side of the enclosure as shown in FIG. 2. While inserting the cap, the fingers flex slightly inward, producing friction and preload. Once the inside surface of the cap reaches the outer surface of the other side of the enclosure, the fingers snap into mating pockets on that side of the enclosure. Removal of the cap is done by placing ones thumb and index finger into domed recesses 28 in the enclosure and pulling straight outward forcing the fingers in the cap to flex enough to overcome the friction holding the cap in place.

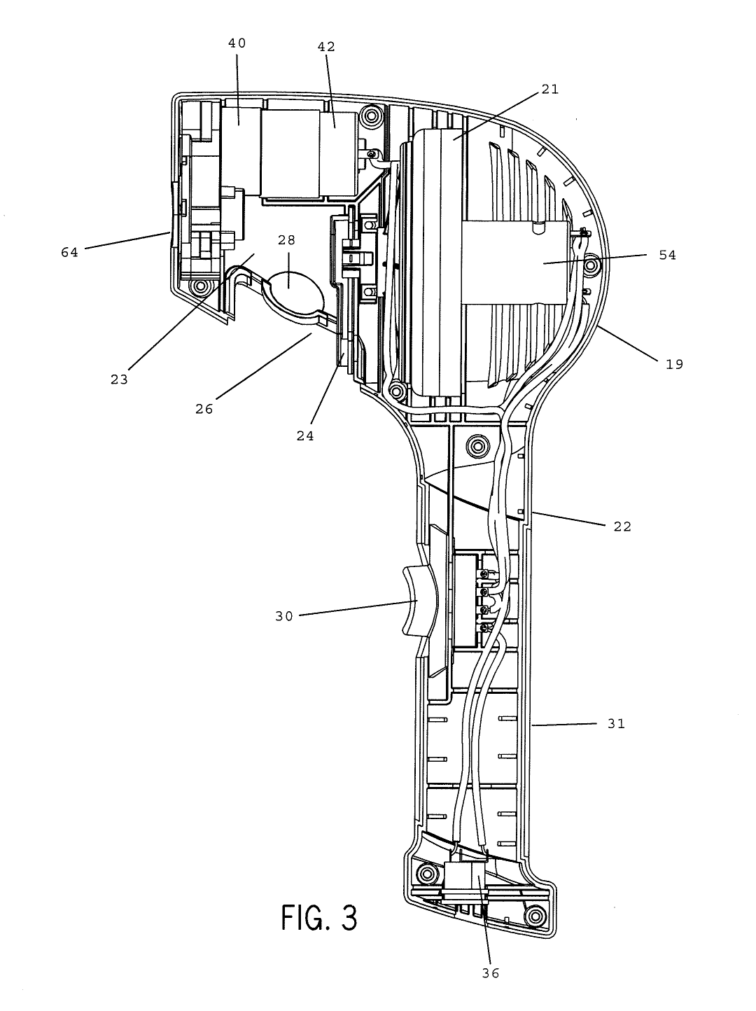

As best seen in FIG. 3, the enclosure 22 also houses a switch 30 which is located in the handle 31 and, when switched on, provides electrical power to the motors in the motorized clipper assembly 20 and motorized suction assembly 21. In one embodiment, the switch 30 has two positions, an off position and an on position, in which the motorized clipper assembly 20 and the motorized suction assembly 21 are activated. In the embodiment shown in FIGS. 1 and 2, the switch 30 has three positions, including an off position 32, a cutting and vacuuming position 33 that energizes both the motorized clipper assembly 20 and the motorized suction assembly 21; and a vacuum only position 34 that energizes only the motorized suction assembly 21. The enclosure also houses a direct current power jack 36 which acts as a connector or a plug to provide power to the hair cutting device. To power the hair cutting device 17 there is an alternating current to direct current transformer 37 which, when plugged into a standard outlet with the standard plug end and plugged into the hair cutting device with the direct current plug, converts high voltage alternating current provided to low voltage direct current needed to energize the electric motors. Of course, other wiring, transformer, and switch arrangements could be used.

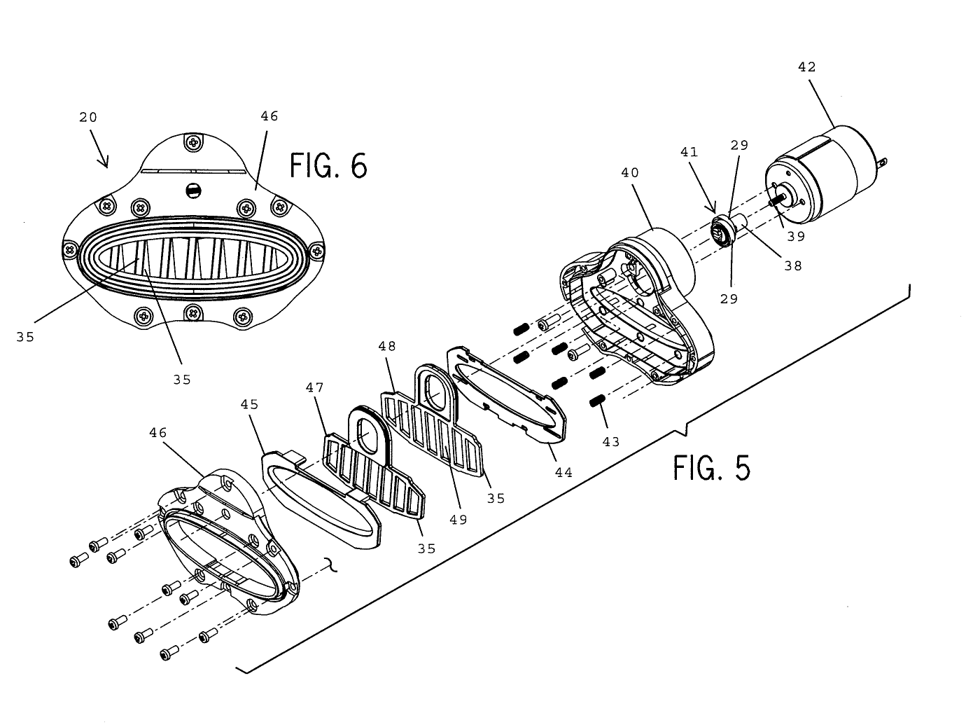

Reference is made to the motorized clipper assembly 20 shown in FIGS. 2, 4, 5 and 6. Cutting of the hair is accomplished by the edges of cutting plates 35 within the motorized clipper assembly 20. In one embodiment, the motorized clipper assembly 20 comprises a clipper assembly main housing 40 which has recessed pockets, that houses a cam assembly 41 (see FIG. 5), a clipper assembly motor 42, preloaded springs 43, a rear guide plate 44, two or more cutting plates 35, a front guide plate 45 and a clipper assembly cover 46. The cam assembly 41 shown better in FIG. 5 consists of a main shaft 38 that presses on to the motor shaft 39 and two bearing assemblies that act as cams 29 which are installed on the main shaft 38 which is mounted orthogonally to the planes of the cutting plates 35. The cam assembly 41 causes the cutting plates 35 to oscillate when the clipper assembly motor 42 is activated. Hair is drawn into the motorized clipper assembly 20 by suction created by the motorized suction assembly 21 and is cut by the edges of the oscillating cutting plates 35. The cams 29 are mounted in opposite phase such that the front cutting plate 47 reaches its maximum excursion toward one side at the same moment the rear cutting plate 48 reaches its maximum excursion toward the opposite side. The balanced configuration and movement of the cams 29 and cutting plates 35 ensures a vibration free operation. The cam assembly 41 is powered by clipper assembly motor 42 housed in the main clipper assembly housing 4 which in turn rotates the cam assembly 41 forcing the oscillation of the cutting plates 35 along the longitudinal axis. The cutting plates 35 are characterized by a row of parallel slots 49 which are oriented obliquely from the direction of oscillation of the plates. (See FIG. 4). The two plates 35 may be made identical to each other; however, they are stacked back-to-back so that the slots of the front cutting plate 47 are slanted in the opposite direction in relation to the slots in the rear cutting plate 48. During the oscillation movement of the cutting plates 35, the edges of the two superimposed slots criss-cross each other to define a series of shearing elements. The slots are spaced and proportioned such that the total aperture of the combined slots during the entire oscillation of the plates remain essentially constant. This prevents pulsations and disturbances of the air flow through the device which could adversely affect the proper alignment of the hair. Hair which is drawn into one of the slots is neatly clipped by the scissor-like action of the edges. These plates are preferably made from stainless steel at a thickness of at least 1.5 millimeters in order to maintain a certain inertia and store sufficient kinetic energy to provide a smooth cutting action. The cutting plates 35 are supported and guided by the front guide place 45 and rear guide plate 44. The preloaded springs 43 evenly distribute and provide preload by holding constant pressure on the rear guide plate 44 which in turn eliminates any front to back movement or vibration. FIG. 4 shows the working components of the motorized clipper assembly in an assembled configuration.

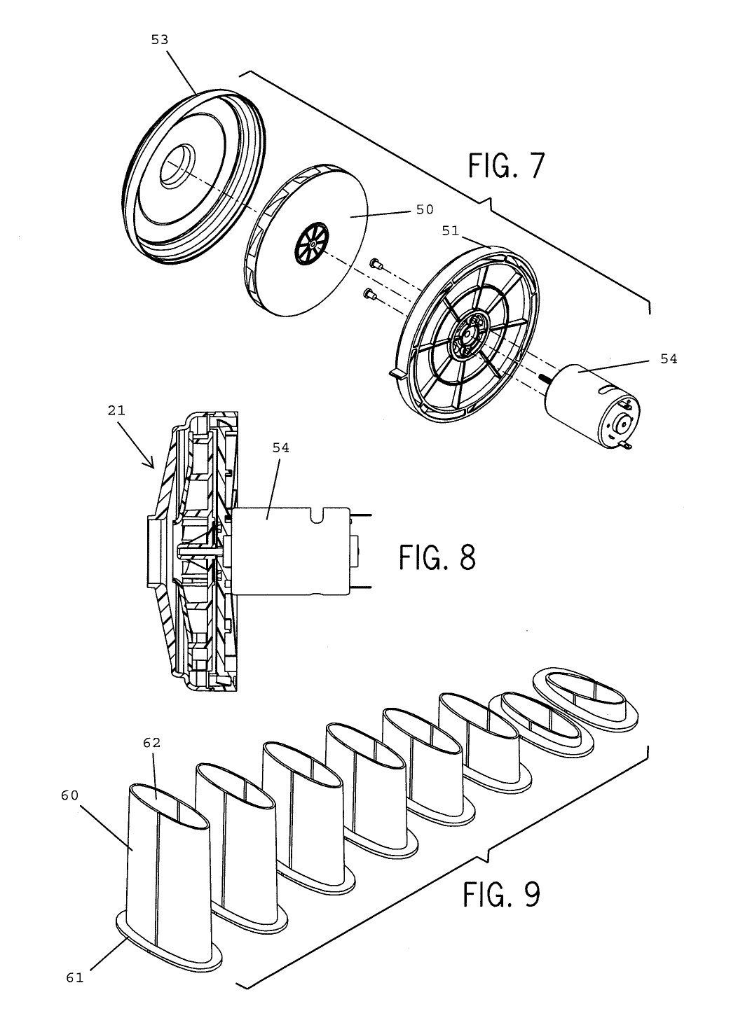

Reference is made to the motorized suction assembly 21 as best seen in FIGS. 3 and 7. In the embodiment shown, the motorized suction assembly 21 comprises an impeller. In another embodiment, the motorized suction assembly comprises an impeller 50, a main housing 51, a suction assembly cover 53, and a suction assembly motor 54. The impeller 50 has a series of veins at a specific pitch and arc to provide maximum air flow through the impeller 50 and optimized for a specific motor rpm. The suction assembly cover 53 has a generous radius near the outer edges of the impeller which assist in a smoother air flow exhaust into the diagonal exhaust chambers as mentioned previously. The suction assembly motor 54, when energized, spins the impeller 50 which is pressed onto the motor shaft causing air to be drawn into the open orifice in the front of the suction assembly cover 53 and exhausted out the enclosure vents which are located on both sides of the suction assembly motor 54. This creates the suction needed to draw hair into the motorized clipper assembly 20. The suction assembly motor 54 may be any motor suitable for providing sufficient suction. In one embodiment, the suction assembly motor 54 is a small direct current electric motor that is designed to run on 24 volts and provides a speed of 19,680 RPM, delivers 97.5 gram-centimeters of torque, and draws 1.0 amp at maximum efficiency. At 70 grams, this motor is both lightweight and sufficiently powerful to provide sufficient suction to the device. Of course, the specific motors used in the device (for both the motorized suction assembly 21 and the motorized clipper assembly 20) may vary and a person of skill in this technology may choose to use any of a variety of motors without departing from the invention.

Reference is made to FIG. 9 which shows a plurality of spacers 60. A spacer 60 is used to keep the motorized clipper assembly 20 positioned at a distance from the base of the hair in order to clip hair to a predetermined but adjustable length. In one embodiment, the spacers 60 are oval shaped tubes defining a channel, having an end 61 that is connectable to the hair cutting device 17 and an opening to receive hair 62. A variety of connecting means may be used to attach the spacers to the hair cutting device. In one embodiment, the oval shaped spacers match the profile of the enclosure 22, (see FIG. 1) the spacers snap into the enclosure via a small raised bump in the base of the spacer and fit into a recessed pocket in the main enclosure mouth 64. A rim at the end of the spacer is flush with the outer front face surface of the enclosure making the spacer 60 secure and unlikely to accidentally fall out during operation. Spacers are provided in a variety of lengths including a tapered length which is designed to fit in either direction. (See FIG. 9). Spacers 60 may also be combs, or have raised combs or ribs that assist in straightening and lifting the hair into the motorized clipper assembly 20 by combing the hair as the user slides the device over the user's scalp. Comb spacers may be tubes, or may also have a solid wall in the center to help maintain constant suction. Spacers 60 may be made from a variety of materials, for example clear polycarbonate, which makes the spacers 60 very durable and reliable.

The components of this device may be made from a variety of materials. For example, most of the components for this device can be made from injection molded plastic, including the enclosure 22, the moveable cover 25, filter 24, spacers 60, motorized clipper assembly components, clipper assembly cover 46, front guide plate 45, rear guide plate 44, clipper assembly main housing 40 and the cam assembly 41, motorized suction assembly components, suction assembly cover 53, impeller 50, and main housing 51. The cutting plates 35 may be stamped from stainless steel sheet metal and the front surface machined flush. Of course, other materials could be used to manufacture all or some of the components.

In use, the hair cutting device 17 is plugged into a standard electrical outlet using a power cord 63. The user decides how much or little hair he would like to cut and applies the appropriate spacer 60 to the device. The user turns the switch 30 to the cutting and vacuuming position 33 which turns on both the suction assembly motor 54 and clipper assembly motor 42. The user then glides the spacer 60 over the area of hair to be cut in a slow and even motion. Once an amount of cutting is completed, the system is turned off. Alternatively, the switch 30 may be turned to the vacuum only position 34 which turns on the motorized suction assembly 21 but not the motorized clipper assembly 20, thereby allowing the user to vacuum up any loose hair. The user can open the movable cover 25 and dispose of the hair. Where the filter is also removable, it would also be removed, cleaned and inspected, and replaced for the next use.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A hair cutting device comprising:
an enclosure;
a motorized suction assembly positioned at least partially within the enclosure, the motorized suction assembly capable of creating suction;
a motorized clipper assembly positioned at least partially within the enclosure, such that suction created by the motorized suction assembly draws hair into the motorized clipper assembly where it is cut when the motorized suction assembly is activated;
a hair-receiving chamber positioned within the enclosure such that pieces of hair cut by the motorized clipper assembly are deposited into the hair-receiving chamber; and
a filter positioned between the motorized suction assembly and the motorized clipper assembly such that the pieces of hair cut by the motorized clipper assembly are prevented from being drawn into the motorized suction assembly.

2. The hair cutting device of claim 1, wherein the motorized suction assembly comprises an impeller rotated by a motor when the motor is energized, rotation of the impeller causing air to be drawn into an open orifice in a cover of the motorized suction assembly and exhausted out of vents thereby creating suction within the enclosure sufficient to draw hair into the motorized clipper assembly.

3. The hair cutting device of claim 1, wherein the motorized clipper assembly comprises:
two cutting plates each having a plurality of parallel slots;
a cam assembly having two cams with striking portions that push the cutting plates when the cams are rotated, where the striking portions of the cams are positioned in opposite phase from one another; and
a motor driving the cam assembly and causing the cams to be rotated, thereby pushing the cutting plates.

4. The hair cutting device of claim 1, wherein the hair-receiving chamber has a movable cover that is contiguous with the enclosure when in a closed position.

5. The hair cutting device of claim 1, wherein the filter is removable.

6. The hair cutting device of claim 1, wherein the enclosure is shaped to receive a spacer used to keep the motorized clipper assembly positioned at a predetermined distance from the base of the hair, the spacer comprising:
a tube defining a channel;
an opening to receive hair; and
an end that can be connected to the hair cutting device.

7. The hair cutting device of claim 1, wherein the enclosure houses a switch, wherein the switch is capable of:
being in an off position wherein neither the motorized suction assembly nor the motorized clipper assembly are activated;
activating the motorized suction assembly only while not activating the motorized clipper assembly; and
activating both the motorized suction assembly and with the motorized clipper assembly.

8. A hair cutting device comprising:
an enclosure;
a motorized suction assembly positioned at least partially within the enclosure, the motorized suction assembly capable of creating suction within the enclosure upon rotation of a motor driven impeller when the motor is energized;
a motorized clipper assembly positioned at least partially within the enclosure such that the suction from the motorized suction assembly draws hair into the motorized clipper assembly, the motorized clipper assembly comprising two cutting plates each having a plurality of parallel slots, a cam assembly with two cams having striking portions that push the cutting plates, and a motor that powers the cam assembly and causes the cams to be rotated so as to push the cutting plates;
a hair-receiving chamber positioned within the enclosure such that pieces of hair cut by the motorized clipper assembly are deposited into the hair-receiving chamber, the hair-receiving chamber having a movable cover contiguous with the enclosure when in a closed position; and
a removable filter positioned between the motorized suction assembly and the motorized clipper assembly positioned such that the pieces of hair cut by the motorized clipper assembly are prevented from being drawn into the motorized suction assembly.
